(19) United States
(12) Patent Application Publication
(10) Pub. No.: US 2014/0173989 A1
(43) Pub. Date: Jun. 26, 2014

(54) SLIDING DOOR

(71) Applicant: HYUNDAI MOTOR COMPANY, Seoul (KR)

(72) Inventor: Jae Hong CHOI, Gyeonggi-do (KR)

(73) Assignee: Hyundai Motor Company, Seoul (KR)

(21) Appl. No.: 13/844,606

(22) Filed: Mar. 15, 2013

(30) Foreign Application Priority Data
Dec. 24, 2012 (KR) 20120152014

(51) Int. Cl. E05F 15/06

(52) U.S. Cl. CPC E05F 15/06
USPC 49/350; 49/324

(57) ABSTRACT

A sliding door includes a door body, a slider member, a rail, a rotating unit, a sliding unit, and a driving unit. The door body opens or closes an opening part of a vehicle body. The slider member is fixed to an inner side of the vehicle body adjacent to the opening part. The rail is slidably disposed on the slider member. The rotating unit has one side rotatably connected to the rail and the other side rotatably connected to a door to rotate the door body with respect to the rail. The sliding unit slides the rail with respect to the slider member. The driving unit is disposed at the rail and drives the sliding unit and the rotating unit.

### CROSS-REFERENCE TO RELATED APPLICATION

This application is based on and claims benefit of priority to Korean Patent Application No. 10-2012-0152014, filed on Dec. 24, 2012 in the Korean Intellectual Property Office, the entire contents of which are hereby incorporated by reference.

### TECHNICAL FIELD

The present inventive concept relates to a sliding door opening or closing a vehicle, and more particularly, to a sliding door capable of improving a degree of freedom in an appearance design of a vehicle body by not forming a rail guiding a sliding operation of the sliding door at an outer side of the vehicle body and capable of being smoothly opened or closed by simultaneously performing a sliding operation and a rotating operation.

### BACKGROUND

Generally, a sliding door installed in a vehicle, which is slid in a front and rear direction of the vehicle, has an advantage in that a space of a side portion of the vehicle may be saved as compared with a door opened or closed by rotation.

As shown in FIG. 1, a sliding door 20 according to the prior art is guided along rails 11, 12, and 13 that are formed in a vehicle body 10. More specifically, according to the prior art, an upper rail 11, a lower rail 12, and a center rail 13 are formed in the vehicle body 10, and the sliding door 20 is movably coupled to the rails 11, 12, and 13.

Due to the above-mentioned configuration, the center rail 13 is exposed to the outside when the sliding door 20 is closed, and the upper and lower rails 11 and 12 are exposed to the outside when the sliding door 20 is opened. Therefore, an aesthetic appearance of the vehicle is deteriorated.

In addition, since the sliding door 20 according to the prior art has a structure in which the sliding door 20 moves along the upper and lower rails 11 and 12 having a straight line shape, upper and lower portions of the sliding door 20 need to be formed in a straight line shape. Therefore, a degree of freedom in a layout in designing the sliding door 20 is decreased.

### SUMMARY

Accordingly, the present inventive concept has been made to solve the above-mentioned problems occurring in the prior art while advantages achieved by the prior art are maintained intact.

An aspect of the present inventive concept relates to a sliding door capable of improving a degree of freedom in an appearance design of a vehicle body and being smoothly opened or closed by installing a rail guiding a sliding operation of a door body at an inner side of the vehicle body and allowing the door body to be opened or closed by a rotating operation and a sliding operation.

One aspect of the present inventive concept encompasses a sliding door including: a door body opening or closing an opening part of a vehicle body; a slider member fixed to an inner side of the vehicle body adjacent to the opening part; a rail slidably mounted on the slider member; a rotating unit having one side rotatably connected to the rail and the other side rotatably connected to a door to rotate the door body with respect to the rail; a sliding unit sliding the rail with respect to the slider member; and a driving unit installed at the rail and driving the sliding unit and the rotating unit.

### BRIEF DESCRIPTION OF THE DRAWINGS

The foregoing and other features of the inventive concept will be apparent from more particular description of embodiments of the inventive concept, as illustrated in the accompanying drawings in which like reference characters may refer to the same or similar parts throughout the different views. The drawings are not necessarily to scale, emphasis instead being placed upon illustrating the principles of the embodiments of the inventive concept.

FIG. 1 is a view showing a sliding door according to the prior art.

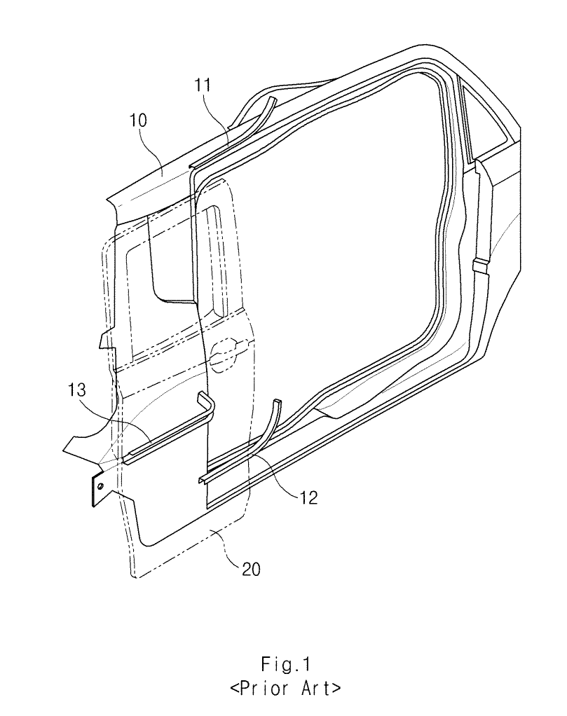

FIG. 2 is a view showing a state in which a sliding door according to an exemplary embodiment of the present inventive concept is assembled.

FIG. 3 is an exploded perspective view of a slider member and a rail of the sliding door according to an exemplary embodiment of the present inventive concept.

FIG. 4 is a view showing a rotating unit of the sliding door according to an exemplary embodiment of the present inventive concept.

FIG. 5 is a view showing a sliding unit of the sliding door according to an exemplary embodiment of the present inventive concept.

### DETAILED DESCRIPTION OF THE PREFERRED EMBODIMENTS

Examples of the present inventive concept will be described below in more detail with reference to the accompanying drawings. The examples of the present inventive concept may, however, be embodied in different forms and should not be construed as limited to the examples set forth herein. Like reference numerals may refer to like elements throughout the specification.

Hereinafter, a sliding door according to an exemplary embodiment of the present inventive concept will be described in detail with reference to the accompanying drawings. In the present specification, an “inner side” and an “outer side” indicate the inside and the outside of a vehicle based on a vehicle body, respectively.

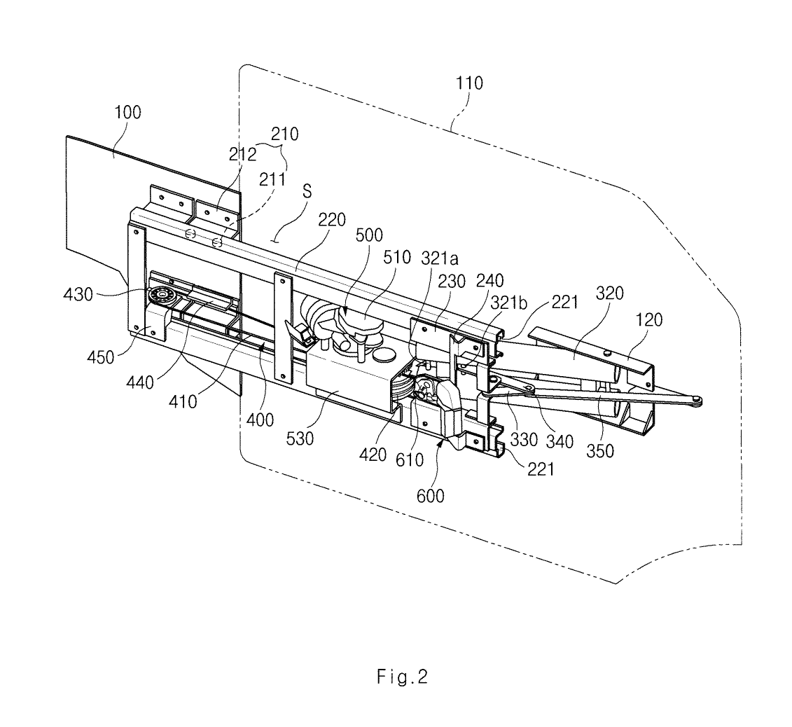

First, as shown in FIG. 2, a sliding door according to an exemplary embodiment of the present inventive concept may include a door body 110 opening or closing an opening part S of a vehicle body 100, as shown in FIG. 2. The door body 110 opens or closes the opening part S while being rotated and slid with respect to the vehicle body 100.

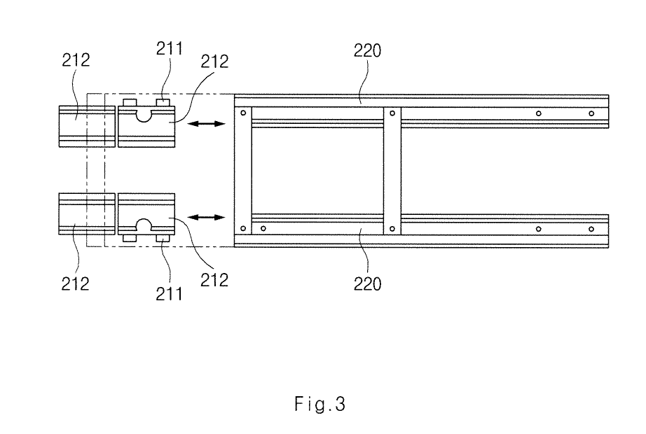

More specifically, as shown in FIGS. 2 and 3, a slider member 210 may be fixed to the vehicle body 100 at a position adjacent to the opening part S of the vehicle body 100. The slider member 210 is configured of two mounting brackets 212 fixed while having a predetermined interval therebetween in a vertical direction and a roller 211 rotatably mounted on the mounting brackets 212.

A rail 220 is slidably mounted on the mounting bracket 212 of the slider member 210. That is, the rail 220 is provided with a guide groove 221 accommodating the two mounting brackets 212 and the roller 211 therein such that the rail 220 is slid with respect to the slider member 210 while rolling-contacting the roller 211 accommodated in the guide groove 221.

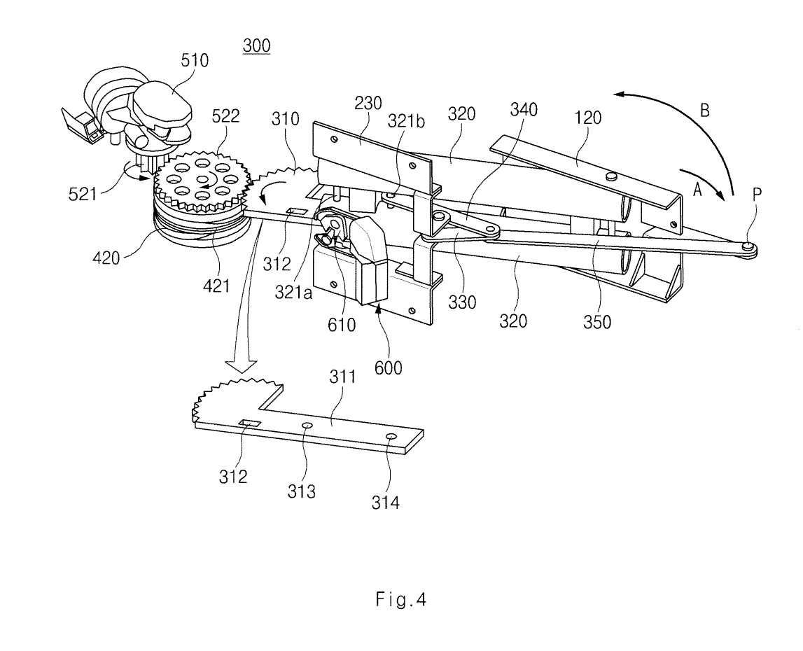

In addition, a central portion of the rail 220 is provided with a driving unit 500 generating driving force for the above-mentioned sliding operation and driving force for a rotating operation of a rotating unit 300 (see FIG. 4) to be described below. More specifically, as shown in FIG. 2, the driving unit 500 has a motor 510 mounted on a motor bracket 530 fixed to the rail 220. The motor 510 is mounted such that a motor shaft (not separately shown) is directed downwardly.

In the rail 220, the rotating unit 300 may be mounted at an end portion of the rail 220 on an opposite side to a portion slidably mounted at the slider member 210. As shown in FIGS. 2 and 4, the rotating unit 300 may have one side rotatably mounted at the rail 220 and the other side rotatably mounted at a door bracket 120 fixed to the door body 110. The rotating unit 300 may include a six-bar link rotating around a support point, e.g., a center shaft 321a (see FIG. 4) to be described below, rotatably mounted at the rail 220 by rotation of the motor 510.

More specifically, as shown in FIG. 4, the rotating unit 300 may be mounted at the motor shaft (not separately shown) of the motor 510 to thereby rotate by the rotation of the motor 510 and may receive rotational force transferred through a driving gear 521 having a gear formed at an outer side thereof. The driving gear 521 may be gear-coupled to a transfer gear 522, which may be gear-coupled to a sector gear 310. Although the transfer gear 522 is directly gear-coupled to the sector gear 310 in an embodiment of the present inventive concept, a decelerating gear decelerating rotation of the transfer gear 522 may also be provided and coupled to the sector gear 310.

Referring to FIG. 4, the rotating unit 300 may include the above-mentioned sector gear 310. The sector gear 310 may have a fan shape in which the sector gear 310 has a gear formed at an outer peripheral surface thereof. One side of the sector gear 310 having the fan shape may be provided with a rectangular straight line part 311. The straight line part 311 may be provided with a center hole 313, which is a rotation center of the fan-shaped sector gear 310, and may be provided with a support hole 314 at a position spaced apart from the center hole 313 by a predetermined interval. In addition, the sector gear 310 is provided with a rectangular latching groove 312. The latching groove 312 is latched by a hold open latch 600 (see FIG. 4) to be described below. The latching groove 312 will be described in detail in the description of the hold open latch 600.

In addition, the six-bar link included in the rotating unit 300 may include a main arm 320 (see FIGS. 2 and 4) having one end fixed to the sector gear 310 and the other end rotatably connected to the door bracket 120 fixed to the door body 110 and first to third guide links 330, 340, and 350, guiding rotation of the main arm 320.

More specifically, the main arm 320 may have the sector gear 310 inserted into one end thereof and has a center shaft 321a and a support shaft 321b vertically inserted into one end thereof, such that the center shaft 321a and the support shaft 321b are rotatably coupled to the center hole 313 and the support hole 314, respectively, of the sector gear 310. With the above-mentioned configuration, when the sector gear 310 rotates, the main arm 320 rotates around the center shaft 321a inserted into the center hole 313 of the sector gear 310.

In addition, the first guide link 330 may have one end rotatably mounted at a body bracket 230 fixed to the rail 220. The second guide link 340 may have one end rotatably mounted at the support shaft 321b positioned at a position spaced apart from the center shaft 321a by a predetermined interval and the other end rotatably connected to the other end of the first guide link 330. In addition, the third guide link 350 may have one end rotatably connected to the other end of the first guide link 330 and the other end of the second guide link 340, and the other end rotatably connected to a support point P (see FIG. 4) of the door bracket 120.

That is, the six-bar link rotating the door body 110 with respect to the rail 220 may be configured of the main arm 320, the body bracket 230, the first to third guide links 330, 340, and 350, and the door bracket 120, which act as six links. The door body 110 is rotated by the six-bar link to thereby be opened or closed.

More specifically, as shown in FIG. 4, when the motor 510 of the driving unit 500 rotates in a counterclockwise direction, the sector gear 310 rotates around the center shaft 321a in the counterclockwise direction through the driving gear 521 and the transfer gear 522. Therefore, the main arm 320 rotates around the center shaft 321a in the counterclockwise direction. At the time of the rotation of the main arm 320, the door body 110 first rotates (a tilting operation) around the support point P at a small angle in an A direction and then rotates (a rotating operation) at a large angle in a B direction, by the above-mentioned six-bar link. That is, the rotating operation of the main arm 320 is changed into the tilting operation and the rotating operation of the door body 110 through the six-bar link. When the door body 110 performs the above-mentioned tilting operation, one side (e.g., the left side in FIG. 2) of the door body 110 is moved to the outside of the vehicle body 100 to thereby be spaced apart from the vehicle body 100. Therefore, the door body 110 is in a state in which one side thereof does not generate interference with the vehicle body 100 and then performs the rotating operation, such that the door body 110 does not hinder an operation of opening the opening part S of the vehicle body 100. When the door body 110 performs an operation of closing the opening part S of the vehicle body 100, it performs an opposite operation of the above-mentioned operation. Therefore, according to an embodiment of the present inventive concept, the door body 110 may be smoothly opened/closed.

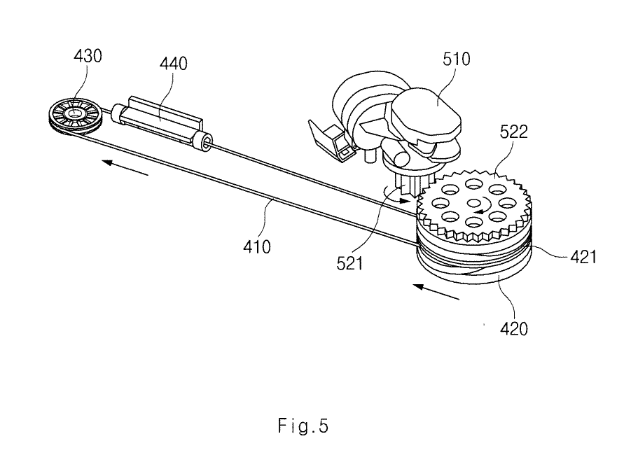

In addition, the rail 220 may be mounted with a sliding unit 400 (see FIG. 2) sliding the rail 220 with respect to the slider member 210. More specifically, as shown in FIGS. 2 and 5, a lower portion of the motor 510 may be provided with a winding drum 420 rotated by the rotation of the motor 510. The winding drum 420 may include a plurality of winding grooves 421 (see FIG. 5) formed in an outer peripheral surface thereof. In addition, the winding drum 420 may have a wire 410 wound therearound. Therefore, when the winding drum 420 rotates, the wire is wound around the plurality of winding grooves 421 formed in the winding drum 420.

In addition, referring to FIG. 2, the rail 220 may have a pulley bracket 450 fixed to one side thereof. The pulley bracket 450 may have a pulley 430 rotatably mounted thereon. In addition, the pulley 430 may have the wire 410 slung thereover. Therefore, the pulley 430 guides movement of the wire 410. In addition, the wire 410 slung between the winding drum 420 and the pulley 430 may be fixed to a wire holder 440 fixed to the vehicle body 100. The wire holder 440 may be positioned between the winding drum 420 and the pulley 430.

That is, the sliding unit 400 may have a structure in which the wire 410 fixed to the vehicle body 100 by the wire holder 440 is slung between the winding drum 420 and the pulley 430. With the above-mentioned structure, when the winding drum 420 rotates by the motor 510, the wire 410 is wound around the winding drum 420. In this case, since the wire 410 is fixed to the vehicle body 100 by the wire holder 440, such that the wire 410 does not move, the length of the wire 410 between the winding drum 420 and the wire holder 440 is decreased by the length of the wire 410 wound around the winding drum 420. Therefore, the winding drum 420 moves toward the wire holder 440, such that the rail 220 is slid toward the wire holder 440. As a result, the door body 110 connected to the rail 220 via the rotating unit 300 is slid. Meanwhile, when the winding drum 420 rotates in an opposite direction, the rail 220 is slid in a direction in which the rail 220 becomes distant from the wire holder 440. As a result, the door body 110 connected to the rail 220 via the rotating unit 300 is slid to close the opening part S of the vehicle body 100.

Meanwhile, as shown in FIG. 2, a latch bracket 240 may be fixed to the body bracket 230 fixed to the rail 220 and may be mounted with the hold open latch 600. One side of the holder open latch 600 may be provided with a latching piece 610. As shown in FIG. 4, the latching groove 312 of the sector gear 310 described above is latched by the latching piece 610.

More specifically, when the sector gear 310 rotates, such that the door body 110 is completely opened, the latching groove 312 of the sector gear 310 is latched by the latching piece 610 of the hole open latch 600. Therefore, since the latching groove 312 of the sector gear 310 is latched by the latching piece 610 of the hole open latch 600 in a state in which the door body 110 is completely opened, the door body 110 is held in the state in which it is completely opened. Then, when force is applied in an opposite direction in order to close the door body 110, the latching groove 312 is separated from the latching piece 610 of the hold open latch 600 to perform a closing operation.

Hereinafter, an action of the sliding door according to an embodiment of the present inventive concept will be described. First, as shown in FIGS. 2 and 4, when the motor 510 of the driving unit 500 rotates in the counterclockwise direction in a state in which the door body 110 is closed, the sector gear 310 of the rotating unit 300 rotates in the counterclockwise direction, and at the same time, the winding drum 420 of the sliding unit 400 rotates in a clockwise direction.

The main arm 320 rotates in the counterclockwise direction by the rotation of the sector gear 310. The door body 110 starts an opening operation according to the rotation of the main arm 320 as described above. More specifically, the door body 110 rotates (the tilting operation) around the support point P in the A direction of FIG. 4 by the six-bar link and then rotates (the rotating operation) in the B direction of FIG. 4. The interference between one side of the door body 110 and the vehicle body 100 is not generated by the above-mentioned tilting operation, so that the rotating operation is smoothly performed.

The wire 410 is wound around the winding drum 420 by the rotation of the winding drum 420 together with the operation of the door body 110 as described above. The length of the wire 410 between the pulley 430 and the winding drum 420 is decreased by the length of the wire 410 wound around the door body 110, such that the winding drum 420 moves toward the wire holder 440. Therefore, the rail 220 is slid with respect to the slider member 210. As a result, the door body 110 connected to the rail 220 is slid to open the opening part S of the vehicle body 100.

In addition, when opening of the door body 110 progresses, such that the sector gear 310 is latched by the hold open latch 600 to latch the rotation of the main arm 320, the door body 110 is held in the state in which the door body 110 is opened.

When the motor 510 of the driving unit 500 rotates in the clockwise direction, which is an opposite direction to the above-mentioned direction, in the state in which the door body 110 is opened as described above, the rotating unit 300 and the sliding unit 400 perform opposite operations to the above-mentioned operations, such that the door body 110 performs a closing operation of closing the opening part S of the vehicle body 100.

As described above, in the sliding door according to an embodiment of the present inventive concept, since the rail 220 is positioned at an inner side of the door body 110 and is also accommodated in the vehicle body 100 while being slid, the rail 220 is not viewed from the outside in the state in which the door body 110 is opened or closed. Therefore, since the rail 220 does not have an effect on an appearance of the vehicle body 100, a degree of freedom in an appearance design may be improved.

In addition, in the sliding door according to an embodiment of the present inventive concept, the door body 110 may be opened or closed while simultaneously performing the rotating operation of the rotating unit 300 and the sliding operation of the sliding unit 400 by the driving of the driving unit 500.

Further, in the sliding door according to an embodiment of the present inventive concept, the rotating operation of the rotating unit 300 and the sliding operation of the sliding unit 400 are simultaneously performed, thereby making it possible to smoothly open or close the door body 110.

In addition, the rotating unit 300 rotates the main arm 320 to allow the door body 110 to continuously perform the rotating operation (the tilting operation) in the A direction (see FIG. 4) and the rotating operation (the rotating operation) in the B direction (see FIG. 4) by the six-bar link as shown in FIG. 4, thereby making it possible to smoothly rotate the door body 110.

In addition, according to the exemplary embodiment of the present inventive concept, the door body is opened or closed while simultaneously performing the rotating operation of the rotating unit and the sliding operation of the sliding unit by the driving of the driving unit, such that the door body may be smoothly operated.

Hereinabove, although the exemplary embodiment of the present inventive concept has been described in detail, the present inventive concept is not limited to the above-mentioned exemplary embodiment, but may be variously modified without departing from the spirit and scope of the present inventive concept defined by the accompanying claims.

What is claimed is:

1. A sliding door, comprising:
a door body for opening or closing an opening part of a vehicle body;
a slider member fixed to an inner side of the vehicle body adjacent to the opening part;
a rail slidably disposed on the slider member;
a rotating unit having one side rotatably connected to the rail and the other side rotatably connected to a door to rotate the door body with respect to the rail;
a sliding unit for sliding the rail with respect to the slider member; and
a driving unit disposed at the rail and configured to drive the sliding unit and the rotating unit.

2. The sliding door according to claim 1, wherein the driving unit is configured to simultaneously perform the sliding of the sliding unit and the rotation of the rotating unit.

3. The sliding door according to claim 1, wherein the rotating unit includes:
a sector gear for rotating at a predetermined angle by a rotation of the driving unit;
a main arm having one end fixed to the sector gear and the other end rotatably connected to the door body to rotate around the one end thereof by the rotation of the sector gear; and
a plurality of guide links connected between the rail and the door body to guide the rotation of the main arm.

4. The sliding door according to claim 3, further comprising a hold open latch fixed to the rail and latching the sector gear when the sector gear rotates at a predetermined angle.

5. The sliding door according to claim 3, wherein the main arm and the plurality of guide links configures a six-bar link such that the six-bar link allows the door body to continuously perform a tilting operation and a rotating operation according to the rotation of the main arm.

6. The sliding door according to claim 1, wherein the sliding unit includes:
a winding drum configured to be rotated by a rotation of the driving unit and having a wire wound therearound;
a pulley disposed at the rail to guide the wire; and
a wire holder fixed to the vehicle body, positioned between the winding drum and the pulley, and fixing the wire.
